(19) United States
(12) Patent Application Publication
(10) Pub. No.: US 2025/0308228 A1
(43) Pub. Date: Oct. 2, 2025

(54) Pixel Classification System Incorporating Quantum Computing with Game Theoretic Optimization and Related Methods

(71) Applicant: Eagle Technology, LLC, Melbourne, FL (US)

(72) Inventors: Mark D. RAHMES, MELBOURNE, FL (US); Michael C. GARRETT, MELBOURNE, FL (US); John PENUEL, INDIAN HARBOUR BEACH, FL (US); Morteza AKBARI, ROCKLEDGE, FL (US)

(21) Appl. No.: 18/616,332

(22) Filed: Mar. 26, 2024

(51) Int. Cl. G06V 10/94; G06N 10/80; G06V 10/70; G06V 10/764; G06V 20/13

(52) U.S. Cl. CPC G06V 10/955; G06V 10/764; G06V 10/87; G06N 10/80; G06V 20/13

(57) ABSTRACT

An image pixel classification device may include a quantum computing circuit configured to perform quantum subset summing, and a processor. The processor may be configured to generate a pairwise game theory reward matrix for a plurality of different classes of an image pixel, with each class corresponding to a respective type of land feature from among a plurality of different types of land features, cooperate with the quantum computing circuit to perform quantum subset summing on the pairwise game theory reward matrix. The processor may further select a class for the image pixel based upon the quantum subset summing, and classify the image pixel as the corresponding type of land feature for the selected class.

### TECHNICAL FIELD

The present disclosure relates generally to quantum computing systems and associated algorithms. More particularly, the present disclosure relates to quantum computing for image detection and classification and related methods.

### BACKGROUND

Automated decision making for strategic scenarios is an area of continued interest. However, many implementations require processing of extremely large amounts of input data, which can be a challenge with classical computing approaches.

Quantum computing shows promise to help provide the enhanced processing capabilities needed for automated decision making in such scenarios. Quantum computers use the properties of quantum physics to store data and perform computations. Quantum computers include specialized hardware on which qubits are stored, controlled and/or manipulated in accordance with a given application. The term “qubit” is used in the field to refer to a unit of quantum information. The unit of information can also be called a quantum state. A single qubit is generally represented by a vector a |0>+b|1>, where a and b are complex coefficients and |0> and |1> are the basis vectors for the two-dimensional complex vector space of single qubits. At least partially due to the qubit structure, quantum computers use the properties of quantum physics to perform computation, enabling advantages that can be applied to certain problems that are impractical for conventional computing devices.

One example approach is set forth in U.S. Pat. Pub. No. 2022/0300843 to Rahmes et al., which is also from the present Applicant and is hereby incorporated herein in its entirety by reference. This publication discloses systems and methods for operating a quantum processor. The method includes receiving a reward matrix at the quantum processor, with the reward matrix including a plurality of values that are in a given format and arranged in a plurality of rows and a plurality of columns. The method further includes converting, by the quantum processor, the given format of the plurality of values to a qubit format, and performing, by the quantum processor, subset summing operations to make a plurality of row selections based on different combinations of the values in the qubit format. The method also further includes using, by the quantum processor, the plurality of row selections to determine a normalized quantum probability for a selection of each row of the plurality of rows, and making, by the quantum processor, a decision based on the normalized quantum probabilities. Further, the method includes causing, by the quantum processor, operations of an electronic device to be controlled or changed based on the decision.

Despite the advantages of such systems, further developments in the utilization of quantum computing techniques may be desirable in certain applications.

### SUMMARY

An image pixel classification device may include a quantum computing circuit configured to perform quantum subset summing, and a processor. The processor may be configured to generate a pairwise game theory reward matrix for a plurality of different classes of an image pixel, with each class corresponding to a respective type of land feature from among a plurality of different types of land features, and cooperate with the quantum computing circuit to perform quantum subset summing on the pairwise game theory reward matrix. The processor may further select a class for the image pixel based upon the quantum subset summing, and classify the image pixel as the corresponding type of land feature for the selected class.

In an example embodiment, the processor may be configured to select a deep learning model from among a plurality thereof based upon the quantum subset summing on the pairwise game theory reward matrix, and classify the image pixel based upon the selected deep learning model. By way of example, the plurality of deep learning models may comprise an Adaptive Moment Estimation (ADAM) solver, a Stochastic Gradient Descent with Momentum (SGDM) solver, and a Root Mean Squared Propagation (RMSProp) solver. Also by way of example, the plurality of different types of land features may comprise at least some of bare earth, building, road, tower, vegetation and water.

In one example implementation, the processor may be configured to generate a land map including the image pixel rendered according to its land feature classification. In accordance with another example implementation, the processor may be configured to generate a flight simulator map including the image pixel rendered according to its land feature classification. More particularly, the processor may be further configured to change the rendering of the image pixel based upon a plurality of different simulated weather conditions. By way of example, the image pixel may comprise a color image pixel or a grayscale image pixel.

A related image pixel classification method is also provided and may include, at a processor, generating a pairwise game theory reward matrix for a plurality of different classes of an image pixel, with each class corresponding to a respective type of land feature from among a plurality of different types of land features. The method may further include, at the processor, cooperating with a quantum computing circuit to perform quantum subset summing on the pairwise game theory reward matrix, selecting a class for the image pixel based upon the quantum subset summing, and classifying the image pixel as the corresponding type of land feature for the selected class.

### BRIEF DESCRIPTION OF THE DRAWINGS

FIG. 1 is a schematic block diagram of a quantum processing system in accordance with an example embodiment.

FIG. 2 is a table illustrating an example reward matrix which may be used with the system of FIG. 1.

FIG. 3 is a table illustrating example subset summing operations by the quantum processor of the system of FIG. 1.

FIG. 4 is a set of graphs for a quantum histogram and quantum normalized probabilities associated with the example of FIG. 3.

FIG. 5 is a schematic diagram of an example quantum comparator circuit which may be used with the system of FIG. 1.

FIGS. 6 and 7 are schematic diagrams of example quantum adder circuits which may be used with the system of FIG. 1.

FIG. 8 is a schematic diagram of an example quantum processor circuit which may be used with the system of FIG. 1.

FIG. 9 is a flow diagram illustrating example quantum processing operations which may be performed by the system of FIG. 1.

FIG. 10 is a schematic block diagram of an image pixel classification device which may utilize quantum computing components and operations such as those illustrated in FIGS. 1-9.

FIG. 11 is schematic block diagram of an example implementation of the processor of FIG. 10.

FIG. 12 is a schematic block diagram illustrating an example implementation of the classification module of the implementation of FIG. 11.

FIG. 13 is a flow diagram illustrating pixel classification operations which may be performed by the processor of FIG. 10 in an example embodiment.

FIG. 14 is a table illustrating a pairwise comparison approach for land feature classification which may be performed by the processor of FIG. 10.

FIG. 15 is a schematic block diagram illustrating a quantum approximation to linear program using subset summing circuitry which may be implemented by the processor of FIG. 10 in an example embodiment.

FIG. 16 is a flow diagram illustrating example method aspects which may be performed by the processor of FIG. 10.

### DETAILED DESCRIPTION

The present description is made with reference to the accompanying drawings, in which exemplary embodiments are shown. However, many different embodiments may be used, and thus the description should not be construed as limited to the particular embodiments set forth herein. Rather, these embodiments are provided so that this disclosure will be thorough and complete. Like numbers refer to like elements throughout.

By way of background, quantum computers exist today that use the properties of quantum physics to store data and perform computations. Quantum computers include specialized hardware on which qubits are stored, controlled and/or manipulated in accordance with a given application. Quantum computers process certain problems faster as compared to conventional computing devices due to their use of qubits to represent multiple problem states in parallel. However, there is no quantum equivalent approach to the classical computing approaches to automated decision-making for strategic scenarios. These classical computing approaches are limited by memory, time and processing constraints. Thus, a quantum approach to automated decision-making for strategic scenarios has been derived which may provide accurate decisions in a faster amount of time as compared to the classical computing approaches for certain complex problems.

Accordingly, the present approach generally concerns system and methods for quantum computing based decision making. The systems and methods employ a quantum algorithm for optimized game theory analysis. The quantum algorithm implements a game theory analysis using a reward matrix and subset summing to make decisions in a relatively efficient and fast manner. The subset summing may be implemented using quantum adder circuits and quantum comparison circuits.

Conventionally, decision making based on a reward matrix has been achieved using linear programming in classical computers using binary bits. Linear programming is a fundamentally different and relatively slow approach as compared to the present quantum computing based approach. As such, an alternative subset summing technique has been derived which can be implemented in quantum computing devices for solving reward matrices. The particulars of the subset summing approach will become evident as the discussion progresses.

The present approach can be used in various applications. For example, the present approach can be used in an image pixel classification configuration, which will be discussed further below. First, an example quantum computing implementation which may be utilized for this application is now described.

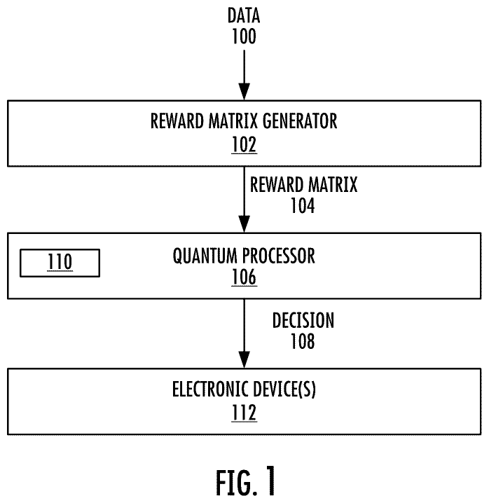

Referring initially to FIG. 1, during operation, data 100 is provided to a reward matrix generator 102. The reward matrix generator 102 processes the data to generate a reward matrix 104. Methods for generating reward matrices are well known. Some known methods for generating reward matrices are based on attributes, objects, keywords, relevance, semantics, and linguistics of input data.

The reward matrix 104 is input into a quantum processor 106. The quantum processor 106 first performs operations to convert the given format (e.g., a binary/bit format) of the reward matrix 104 into a quantum/qubit format. Techniques for converting bits into qubits are known. The qubits are stored in quantum registers 110 of the quantum processor 106. Quantum registers are known, and techniques for storing qubits in quantum registers are known.

The quantum processor 106 uses the qubits to perform subset summing operations in which a plurality of row selections 108 are made based on different combinations of values in the reward matrix 104. Each row of the reward matrix 104 has a respective choice (or decision) associated therewith. These choices (or decisions) can include, but are not limited to, actions, tasks, directions, plans, grids, positions, acoustic ray traces, tags, paths, machine learning algorithms, network nodes, people, emotions/personalities, business opportunities, and/or vehicles (e.g., cars, trucks, and/or aircrafts), as will be discussed further below.

Next, the quantum processor 106 analyzes the row selections 108 resulting from the subset summing operations, and determines total counts for each row selection. For example, a first row of the reward matrix was selected 32 times, thus the total count for the first row is 32. A second row of the reward matrix was selected 59 times, thus the total count for the second row is 59. Similar analysis is performed for the third row. The present approach is not limited to the particulars of this example. A histogram of the total counts may then be generated. Quantum normalized probabilities are determined for the row selections. Normalization can be performed as typically done, or after subtracting a value equal to the number of combinations that have only a single choice considered. The quantum processor 106 makes decision(s) 108 based on the best quantum normalized probability(ies).

The quantum processor 106 also performs operations to cause operations of electronic device(s) 112 to be controlled in accordance with the decision(s) 108. Although the quantum processor 106 is shown as being external to the electronic device 112, the present approach is not limited in this regard. The quantum processing can be part of, disposed inside or otherwise incorporated or integrated with the electronic device 112. The electronic device 112 may include, but is not limited to, a sensor (e.g., an environmental sensor, a camera, a drone, a sound source for ray tracing), a network node, a computing device, a robot, a vehicle (e.g., manned, tele-operated, semi-autonomous, and/or autonomous) (e.g., a car, a truck, a plane, a drone, a boat, or a spacecraft), and/or a communication device (e.g., a phone, a radio, a satellite).

For example, a sensor (e.g., a camera, an unmanned vehicle (e.g., a drone), or a sound source for acoustic ray tracing) may be caused to (i) change position (e.g., field of view and/or antenna direction), location or path of travel, and/or (ii) perform a particular task (capture video, perform communications on a given channel, or ray tracing) at a particular time in accordance with decision(s) of the quantum processor 106. This may involve transitioning an operational state of the sensor from a first operational state (e.g., a power save state or an off state) to a second operational state (e.g., a measurement state or on state). A navigation parameter of a vehicle (e.g., a car, a ship, a plane, a drone) or a robot may be caused to change in accordance with the decision(s) of the quantum processor. The navigation parameter can include, but is not limited to, a speed, and/or a direction of travel. A network may be caused to dynamically change a resource allocation in accordance with the decision(s) of the quantum processor. An autonomous vehicle can be caused to use a particular object classification scheme (e.g., assign a particular object classification to a detected object or data point(s) in a LiDAR point cloud) or trajectory generation scheme (e.g., use particular object/vehicle trajectory definitions or rules) in accordance with the decision(s) of the quantum processor so as to optimize autonomous driving operations (e.g., accelerate, decelerate, stop, turn, etc.). A cognitive radio can be controlled to use a particular machine learning algorithm to facilitate optimized wireless communications (e.g., via channel selection and/or interference mitigation) in accordance with the decision(s) of the quantum processor. A computing device can be caused to take a particular remedial measure to address a malicious attack (e.g., via malware) thereon in accordance with the decision(s) of the quantum processor. The present approach is not limited to the particulars of these examples.

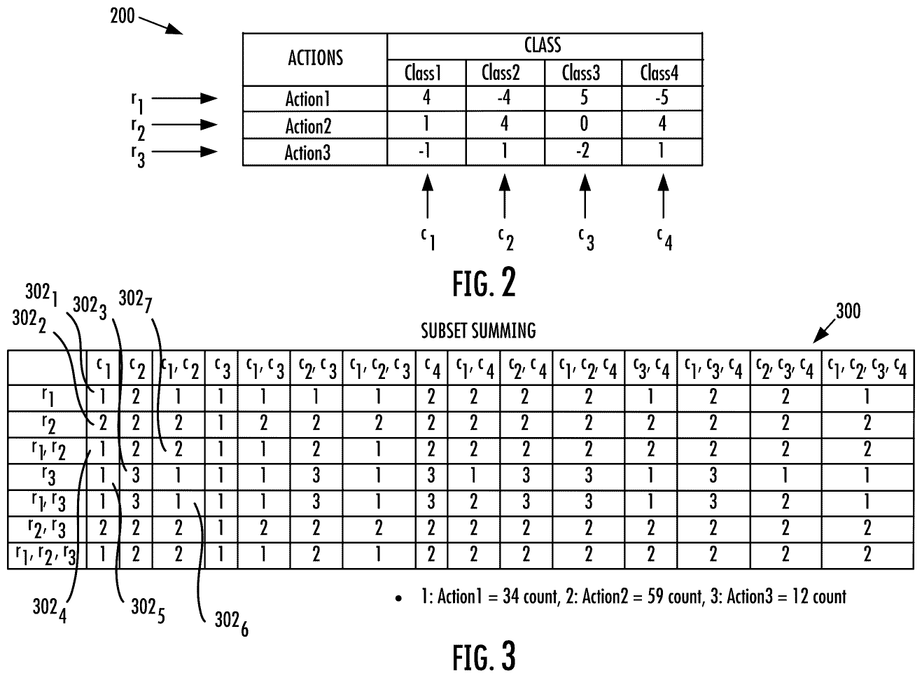

An example reward matrix 200 is illustrated in FIG. 2. Reward matrix 104 of FIG. 1 may be the same as or similar to reward matrix 200. As such, the discussion of reward matrix 200 is sufficient for understanding reward matrix 104 of FIG. 1.

Reward matrix 200 illustratively includes a plurality of rows rₙ and a plurality of columns cₙ. Each row has an action assigned thereto. For purposes of explanation, an example scenario involving vehicle operations is used, in which a first row r₁ has Action1 (e.g., fire) assigned thereto. A second row r₂ has Action2 (e.g., advance) assigned thereto. A third row r₃ has Action3 (e.g., do nothing) assigned thereto. Each column has a class assigned thereto. For example, a first column c₂ has a Class1 (e.g., an enemy truck) assigned thereto. A second column c₂ has a Class2 (e.g., civilian truck) assigned thereto. A third column c₃ has a Class3 (e.g., opponent vehicle) assigned thereto. A fourth column c₄ has a Class4 (e.g., a friendly vehicle) assigned thereto. A value is provided in each cell which falls within a given range, for example, −5 to 5.

A table 300 is provided in FIG. 3 that is useful for understanding an illustrative subset summing algorithm using the reward matrix 200 as an input. Table 300 shows subset summing results for different combinations of rows and columns in the reward matrix. Each subset summing result has a value between 1 and 3. A value of 1 indicates that a row r₁ and/or an Action1 is selected based on results from subset summing operation(s). A value of 2 indicates that a row r₂ and/or an Action2 is selected based on results from subset summing operation(s). A value of 3 indicates that a row r₃ and/or an Action3 is selected based on results of subset summing operation(s).

For example, a value of 1 is provided in a cell 302₁ of table 300 since only one value in the reward matrix 200 is considered in a subset summing operation. The value of the reward matrix 200 is 4 because it resides in the cell which is associated with row r₁ and column c₁. The subset summing operation results in the selection of row r₁ and/or Action1 since 4 is a positive number and the only number under consideration. Therefore, a value of 1 is added to cell 302₁ of table 300.

A value of 2 is provided in cell 302₂ of table 300 since only one value in the reward matrix 200 is considered in a subset summing operation. The value of the reward matrix 200 is 1 because it is in the cell which is associated with row r₂ and column c₁. The subset summing operation results in the selection of row r₂ and/or Action2 since 1 is a positive number and the only number under consideration. Therefore, a value of 2 is added to cell 302₂ of table 300.

A value of 3 is provided in cell 302₃ of table 300 since only one value in the reward matrix 200 is considered in a subset summing operation. The value of the reward matrix 200 is 1 because it is in the cell which is associated with row r₃ and column c₂. The subset summing operation results in the selection of row r₃ and/or Action3 since 1 is a positive number and the only number under consideration. Therefore, a value of 3 is added to cell 302₃ of table 300.

A value of 1 is in cell 302₄ of table 300. In this case, two values in the reward matrix 200 are considered in a subset summing operation. The values of the reward matrix 200 include (i) 4 because it resides in the cell which is associated with row r₁ and column c₁, and (ii) 1 because it resides in the cell which is associated with row r₂ and column c₁. The two values are compared to each other to determine the largest value. Since 4 is greater than 1, row r₁ and/or Action1 is selected. Accordingly, a value of 1 is inserted into cell 302₄ of table 300.

It should be noted that other values of reward matrix 200 are considered when a negative value is the only value under consideration. For example, a value of 1 is in cell 302₅ of table 300 rather than a value of 3. This is because a value of −1 resides in the cell of reward matrix 200 that is associated with row r₃ and column c₁. Since this value is negative, other values in column c₁ of reward matrix 200 are considered. These other values include (i) 4 because it resides in the cell of the reward matrix 200 which is associated with row r₁ and column c₁, and (ii) 1 because it resides in the cell of the reward matrix 200 which is associated with row r₂ and column c₁. These two other values are compared to each other to determine the largest value. Since 4 is greater than 1, row r₁ and/or Action1 is selected. Accordingly, a value of 1 is inserted into cell 302₅ of table 300.

When values in two or more columns and rows of reward matrix 200 are considered and a single cell of reward matrix 200 has the greatest value of the values under consideration, an action is selected that is associated with the cell having the greatest value. For example, a value of 1 is in cell 302₆ of table 300. In this case, values in two columns c₁ and c₂ and two rows r₁ and r₃ of reward matrix 200 are considered. For row r₁, the values include 4 and −4. For row r₃, the values include −1 and 1. The four values are compared to each other to identify the greatest value. Here, the greatest value is 4. Since 4 is in a cell associated with Action1, row r₁ and/or Action1 is selected and a value of 1 is inserted into cell 302₆ of table 300.

It should be noted that an addition operation may be performed for each row prior to performance of the comparison operation. For example, a value of 2 is in cell 302₇ of table 300. In this case, values in two columns c₁ and c₂ and two rows r₁ and r₂ of reward matrix 200 are considered. For row r₁, the values include 4 and −4. For row r₂, the values include 1 and 4. Since both rows r₁ and r₂ include the greatest value of 4, an addition operation is performed for each row, i.e., r₁=4+−4=0, r₂=1+4=5. Since 5 is greater than 0, row r₂ and/or Action1 is selected. Thus, a value of 2 is inserted into cell 302₇ of table 300, rather than a value of 1.

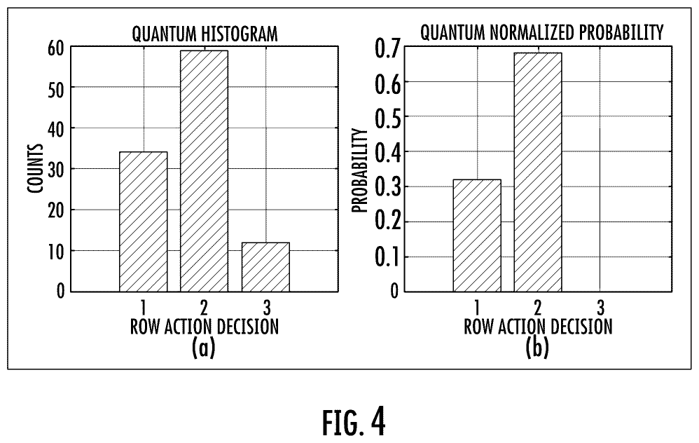

Once table 300 is fully populated, a total count is determined for each value 1, 2 and 3 in table 300. For example, there are 34 occurrences of value 1 in table 300, thus the total count for 1 is 34. A total count for 2 is 59. A total count for 3 is 12. A quantum histogram for the total counts is provided in FIG. 4(a).

Quantum normalized probabilities for row decisions may also be determined. Techniques for determining quantum normalized probabilities are known. Normalization can be performed as typically done, or after subtracting a value equal to the number of combinations that have only a single choice considered. A graph showing the quantum normalized probability for each row action decision is provided in FIG. 4(b). FIG. 4(b) indicates that row r₁ and/or Action1 should be selected 31.884% of the time, row r₂ and/or Action2 should be selected 68.116% of the time, and row r₃ and/or Action3 should be selected 0% of the time. The output of the subset summing operations is Action2 since it is associated with the best quantum normalized probability.

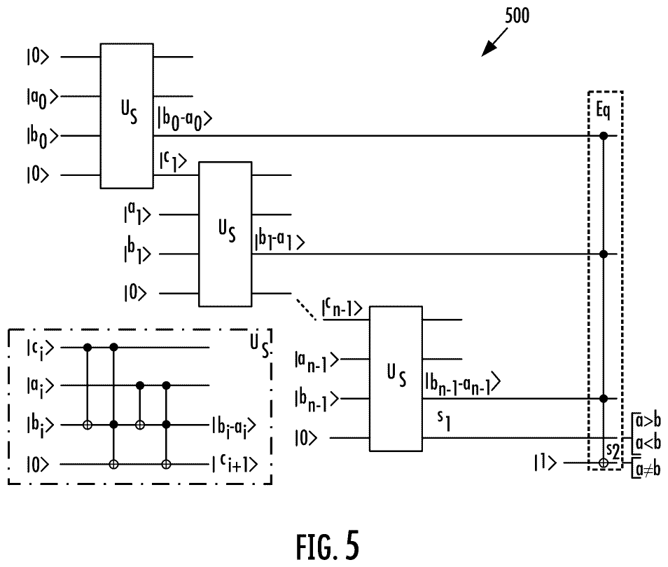

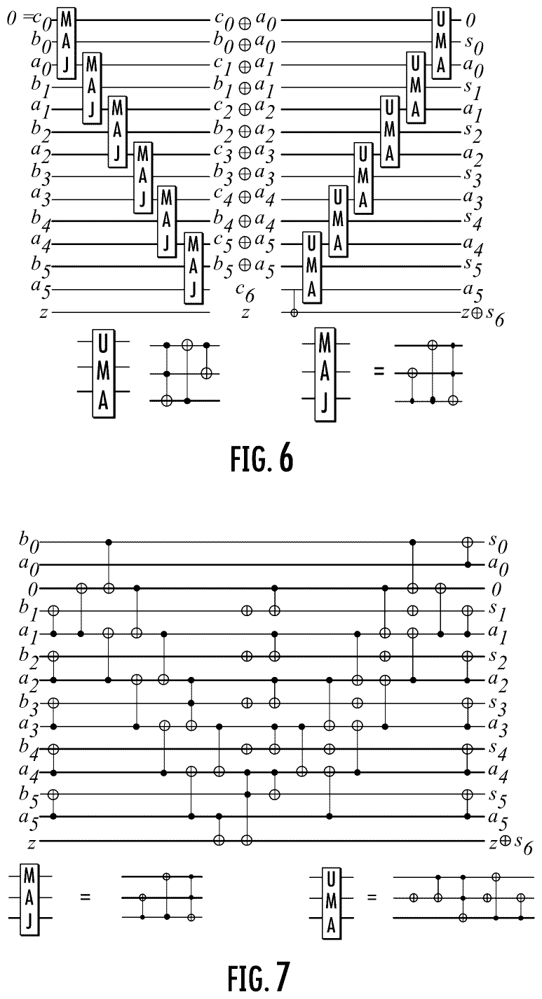

Quantum circuits have been constructed to support the addition and comparison of two binary numbers. These quantum circuits can be used to implement the above described subset summing algorithm. More specifically, the above described subset summing algorithm can be implemented using quantum comparator circuits and quantum adder circuits. The quantum comparator circuit can be used to implement conditional statements in quantum computation. Quantum algorithms can be used to find minimal and maximal values. The quantum adder circuit can be used to assembly complex data sets for comparison and processing. An illustrative quantum comparator circuit is provided in FIG. 5. An illustrative quantum adder circuit is provided in FIG. 6.

As shown in FIG. 5, the quantum comparator circuit 500 includes a quantum bit string comparator configured to compare two strings of qubits aₙ and bₙ using subtraction. Quantum comparator circuit 500 is known. Still, it should be understood that each string comprises n qubits representing a given number. Qubit string a, can be written as aₙ=aₙ₋₁, . . . , a₀, where a₀ is the lowest order bit. Qubit string bₙ can be written as bₙ=bₙ₋₁, . . . , b₀, where b₀ is the lowest order bit. The qubits are stored in quantum registers using quantum gate operators.

This comparison is performed to determine whether the qubit string aₙ is greater than, less than, or equal to the qubit string bₙ. The comparison operation is achieved using a plurality of quantum subtraction circuits Us. Each quantum subtraction circuit is configured to subtract a quantum state |aᵢ> from a quantum state |bᵢ> via XOR (⊕) operations, and pass the result to a quantum gate circuit Eq. A quantum state for a control bit c is also passed to a next quantum subtraction circuit for use in a next quantum subtraction operation. The last quantum subtraction circuit outputs a decision bit s₁. If the qubit string an is greater than the qubits string bₙ, then an output bit s₁ is set to a value of 1. If the qubit string aₙ is less than the qubits string bₙ, then an output bit s₁ is set to a value of 0.

The quantum gate circuit Eq orders the subtraction results and uses the ordered subtraction results |b₀−a₀>, |b₁−a₁>, . . . , |bₙ₋₁−aₙ₋₁> to determine whether the qubit string aₙ is equal to the qubits string bn. If so, an output bit s₂ is set to a value of 1. Otherwise, the output bit s₂ is set to a value of 0.

As shown in FIGS. 6 and 7, the quantum adder circuit 600, 700 comprises a quantum ripple-carry addition circuit configured to compute a sum of the two strings of qubits an and bn together. The quantum ripple-carry addition circuits shown in FIGS. 6-7 are well known. The circuits of FIGS. 6 and 7 implement an in-place majority (MAJ) gate with two Conditioned-NOT (CNOT) gates and one Toffoli gate. The MAJ gate is a logic gate that implements the majority function via XOR (⊕) operations. In this regard, the MAJ gate computes the majority of three bits in place. The MAJ gate outputs a high when the majority of the three input bits are high value, or outputs a low when the majority of the three input bits are low. The circuit of FIG. 6 implements a 2-CNOT version of the UnMajority and Add (UMA) gate, while the circuit of FIG. 7 implements a 3-CNOT version of the UMA gate. The UMA gate restores some of the majority computation, and captures the sum but in the b operand.

The qubit string an can be written as aₙ=aₙ₋₁, . . . , a₀, where a₀ is the lowest order bit. Qubit string bₙ can be written as bₙ=bₙ₋₁, . . . , b₀, where b₀ is the lowest order bit. Qubit string aₙ is stored in a memory location Aₙ, and qubit string bₙ is stored in a memory location Bₙ. cₙ represents a carry bit. The MAJ gate writes cₙ₊₁ into Aₙ, and continues a computation using cₙ₊₁. When done using cₙ₊₁, the UMA gate is applied which restores aₙ to Aₙ, restores cₙ to Aₙ₋₁, and writes Sₙ to Bₙ.

Both circuits of FIGS. 6 and 7 are shown for strings including 6 bits. The present approach is not limited in this regard. A person skilled in the art would understand that the circuits of FIGS. 6 and 7 can be modified for any number of bits n in strings aₙ and bₙ.

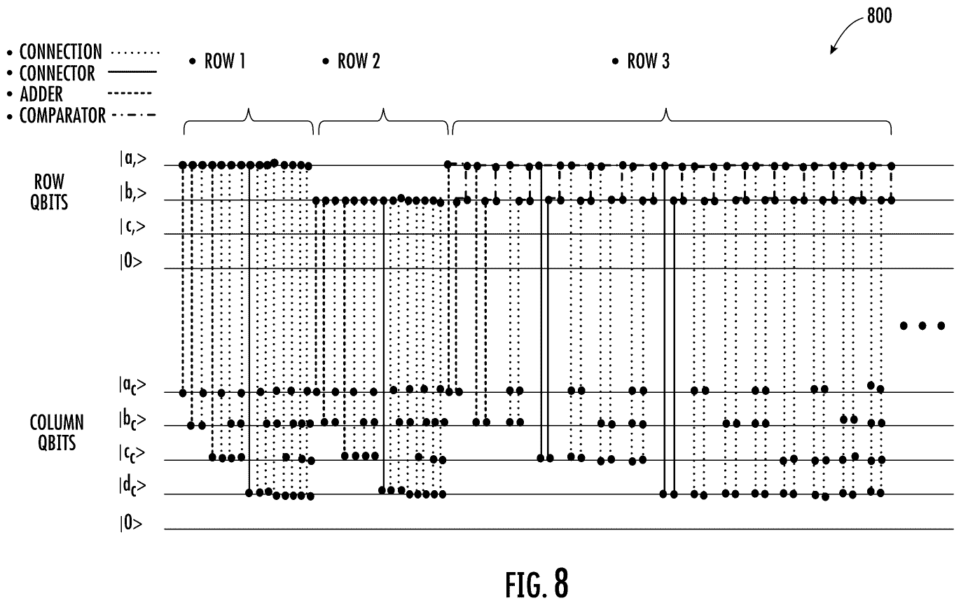

An illustrative quantum processor 800 implementing the subset summing algorithm of the present approach is shown in FIG. 8. The quantum processor 106 of FIG. 1 can be the same as or similar to quantum processor 800. As such, the discussion of quantum processor 800 is sufficient for understanding quantum processor 106 of FIG. 1.

As shown in FIG. 8, quantum processor 800 illustratively includes a plurality of quantum adder circuits and a plurality of quantum comparison circuits. The quantum adder circuits may include, but are not limited to, the quantum adder circuit 600 of FIG. 6 and/or quantum adder circuit 700 of FIG. 7. The quantum comparison circuits may include, but are not limited to, the quantum comparator circuit 500 of FIG. 5.

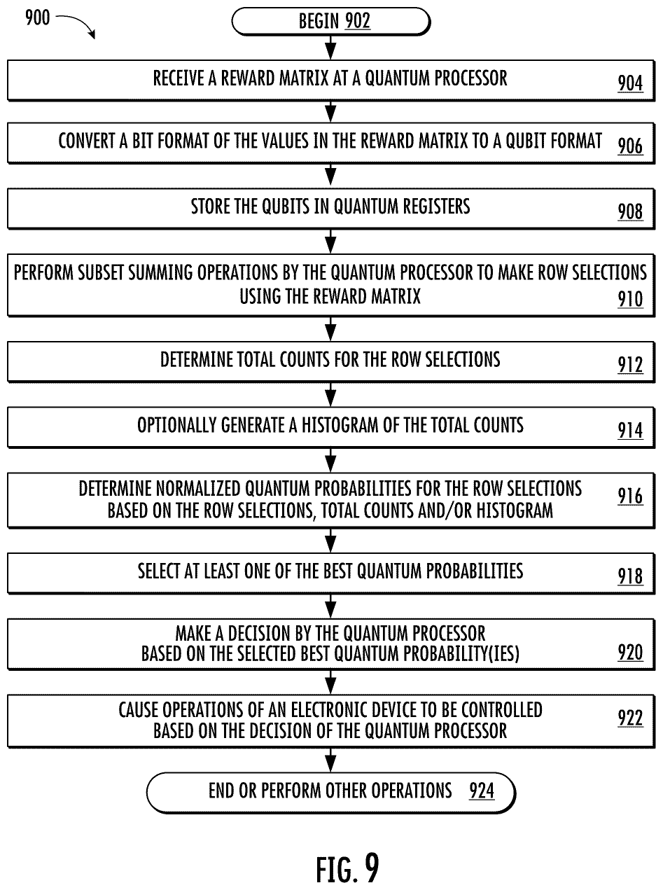

Referring now to FIG. 9, there is provided a flow diagram 900 of an example method for operating a quantum processor (e.g., quantum processor 106 of FIG. 1 and/or 800 of FIG. 8). The method 900 begins with Block 902 and continues with Block 904 where a reward matrix (e.g., reward matrix 104 of FIG. 1 and/or 200 of FIG. 2) is received at the quantum processor. The reward matrix comprises a plurality of values that are in a given format (e.g., a bit format) and arranged in a plurality of rows (e.g., rows r₁, r₂ and r₃ of FIG. 2) and a plurality of columns (e.g., columns c₁, c₂, c₃ and c₄ of FIG. 2). Each row of the reward matrix has a respective choice (or decision) associated therewith. The respective choice (or decision) can include, but is not limited to, a respective action of a plurality of actions, a respective task of a plurality of tasks, a respective direction of a plurality of directions, a respective plan of a plurality of plans, a respective grid of a plurality of grids, a respective position of a plurality of positions, a respective acoustic ray trace of a plurality of acoustic ray traces, a respective tag of a plurality of tags, a respective path of a plurality of paths, a respective machine learning algorithm of a plurality of machine learning algorithms, a respective network node of a plurality of network nodes, a respective person of a group, a respective emotion of a plurality of emotions, a respective personality of a plurality of personalities, a respective business opportunity of a plurality of business opportunities, and/or a respective vehicle of a plurality of vehicles.

In Block 906, the quantum processor performs operations to convert the given format (e.g., bit format) of the plurality of values to a qubit format. Methods for converting bits to qubits are known. Next in Block 908, the quantum processor performs subset summing operations to make a plurality of row selections based on different combinations of the values in the qubit format. The subset summing operations may be the same or similar to those discussed above in relation to FIGS. 3-4.

The subset summing operations may be implemented by a plurality of quantum adder circuits and a plurality of quantum comparator circuits. The subset summing operations may comprise an operation in which at least one value of the reward matrix is considered and which results in a selection of the row of the reward matrix in which the value(s) reside(s). Additionally or alternatively, the subset summing operations may include: an operation in which at least two values of the reward matrix are considered and which results in a selection of the row of the reward matrix in which a largest value of the at least two values resides; an operation in which a single negative value of the reward matrix is considered and which results in a selection of the row of the reward matrix which is different than the row of the reward matrix in which the single negative value resides; an operation in which a plurality of values in at least two columns and at least two rows are considered, and which results in a selection of the row of the reward matrix associated with a largest value of the plurality of values in at least two columns and at least two rows; and/or an operation in which a plurality of values in at least two columns and at least two rows are considered, and which results in a selection of the row of the reward matrix associated with a largest sum of values in the at least two columns.

In Blocks 912-916, the quantum processor uses the plurality of row selections to determine a normalized quantum probability for a selection of each row of the plurality of rows. Blocks 912-916 involve: determining total counts for the row selections; optionally generating a histogram of the total counts; and determining normalized quantum probabilities for the row selections based on the row selections made in Block 910, total counts determined in Block 912 and/or histogram generated in Block 914. Methods for determining normalized quantum probabilities are known. In some scenarios, a normalized quantum probability is determined by dividing a total count for a given row by a total number of row selections (e.g., a total count for a row r1 is 32 and a total number of row selections is 105 so the normalized quantum probability=34/105=approximately 32%).

In Block 918, the quantum processor selects at least one of the best quantum probabilities from the normalized quantum probabilities determined in Block 916. The quantum processor makes a decision (e.g., decision 108 of FIG. 1) in Block 920 based on the selected best quantum probability(ies). In Block 922, the quantum processor causes operations of an electronic device (e.g., electronic device 112 of FIG. 1) to be controlled or changed based on the decision.

For example, the quantum processor causes the electronic device to transition operational states (e.g., from an off state to an on state, or vice versa), change position (e.g., change a field of view or change an antenna pointing direction), change location, change a navigation parameter (e.g., change a speed or direction of travel), perform a particular task (e.g., schedule an event), change a resource allocation, use a particular machine learning algorithm to optimize wireless communications, and/or use a particular object classification scheme or trajectory generation scheme to optimize autonomous driving operations (e.g., accelerate, decelerate, stop, turn, perform an emergency action, perform a caution action, etc.).

The implementing systems of method 900 may include a circuit (e.g., quantum registers, quantum adder circuits, and/or quantum comparator circuits), and/or a non-transitory computer-readable storage medium having computer-executable instructions that are configured to cause the quantum processor to implement method 900. Further details regarding quantum computing configurations which may be used in the example embodiments set forth herein are provided in co-pending U.S. application Ser. No. 17/200,388, which is also assigned to the present Applicant and hereby incorporated herein in its entirety by reference.

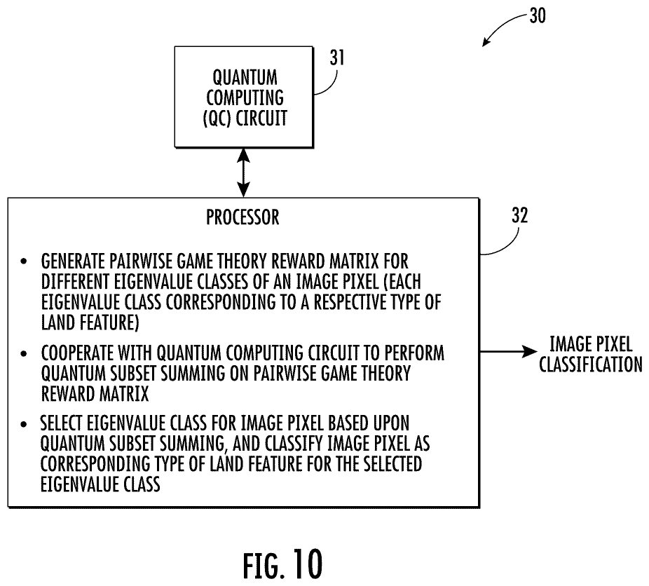

Turning to FIG. 10, an image pixel classification device 30 which may incorporate the above-described quantum processing components and operations is now described. The device 30 illustratively includes a quantum computing circuit 31, which may be similar to the quantum processor 106 described above and similarly configured to perform quantum subset summing. The device 30 also illustratively includes a processor 32, which also may be implemented using similar circuitry and non-transitory computer readable medium as discussed above. As will be discussed further below, the processor 32 may be configured to generate a pairwise game theory reward matrix for a plurality of different classes of an image pixel, where each class corresponds to a respective type of land feature from among a plurality of different types of land features. The processor 32 may also cooperate with the quantum computing circuit 31 to perform quantum subset summing on the pairwise game theory reward matrix, select a class for the image pixel based upon the quantum subset summing, and classify the image pixel as the corresponding type of land feature for the selected class.

By way of background, remote sensing requires that image analysts have the capability to identify regions in imagery that correspond to a particular object or material. The automatic extraction of image areas that represent a feature of interest generally involves two steps. The first is to accurately classify the pixels that represent the region while minimizing misclassified pixels. The second is a vectorization step that extracts a contiguous boundary along each classified region which, when paired with its geo-location, can be inserted in a feature database independent of the image.

The amount of available high-resolution satellite imagery, and the increasing rate at which it is acquired, simultaneously present interesting opportunities and difficult challenges for the simulation and visualization industry. Updating material classification product databases frequently using high-resolution panchromatic and multispectral imagery is typically only feasible if the time and labor costs for extracting features, such as pixel labeling, and producing products from the imagery, are significantly reduced. The device 30 may advantageously help provide flexible and extensible automated workflows for land use land cover (LULC) pixel labeling and material classification, which in turn may allow for accelerated review and quality control for feature extraction accuracy.

In this regard, the device 30 may provide a technical advantage of significantly reducing the quantity of data an analyst has to manually review, yet while maintaining the high quality of the resulting products. The data reduction may be achieved through batch processing the area of interest (AOI) to identify those feature classes in which analysts are interested. The present approach may also utilize game theory to extract pixel labels, provide tools for analyst review and post processing, and produce inputs to the material classification process, as will be discussed further below. Batch processing may be initiated by the process workflow manager specifying the input AOI imagery, processing parameters and the output products desired.

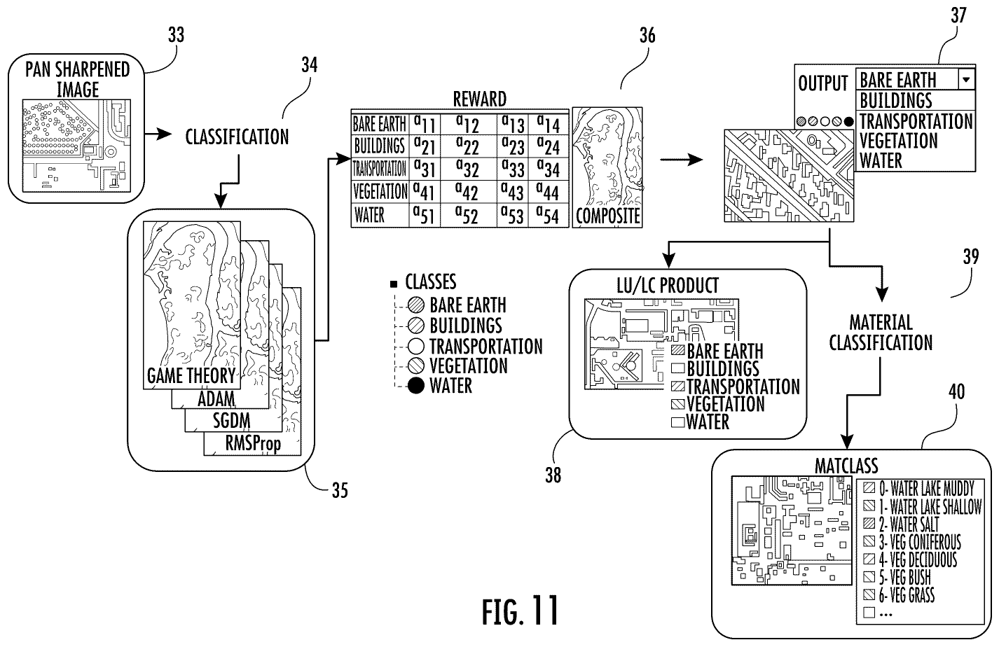

Referring additionally to FIG. 11, an example pixel labeling implementation for the processor 32 is shown. In the illustrated configuration, an optical image 33 (e.g., a pan sharpened optical image) is provided to a classification module of the processor 32. In some embodiments, the processor 32 may use an ensemble of quantum neural network (QNN) machine (deep) learning models and optimally chose the best model with a linear program approximation to improve system accuracy pixel labeling for material classification. By way of example, the classification module 34 may select a best deep learning model from a plurality of different deep learning module (e.g., an Adaptive Moment Estimation (ADAM) solver, a Stochastic Gradient Descent with Momentum (SGDM) solver, and a Root Mean Squared Propagation (RMSProp) solver, etc.) using game theory, as illustrated at Block 35. A reward matrix module 36 generates the pairwise game theory reward matrix for a plurality of different classes of an image pixel. As will be discussed further below, the pairwise reward matrix advantageously allows for integration with quantum computing qubit processing. An output module 37 may advantageously be used to generate LU/LC products 38 such as land use maps, flight simulator maps, etc. The output module 37 may further cooperate with a material classification module 39 to provide further granularity from the different classes of the pixels, such as to determine and output (e.g., on a MatClass map 40) sub-categories of water features (e.g., lake muddy, lake shallow, salt), vegetation (e.g., coniferous, deciduous, bush, grass), etc. Further details regarding example QNN configurations which may be used in the present embodiment are also set forth in the above-noted U.S. application Ser. No. 17/200,388.

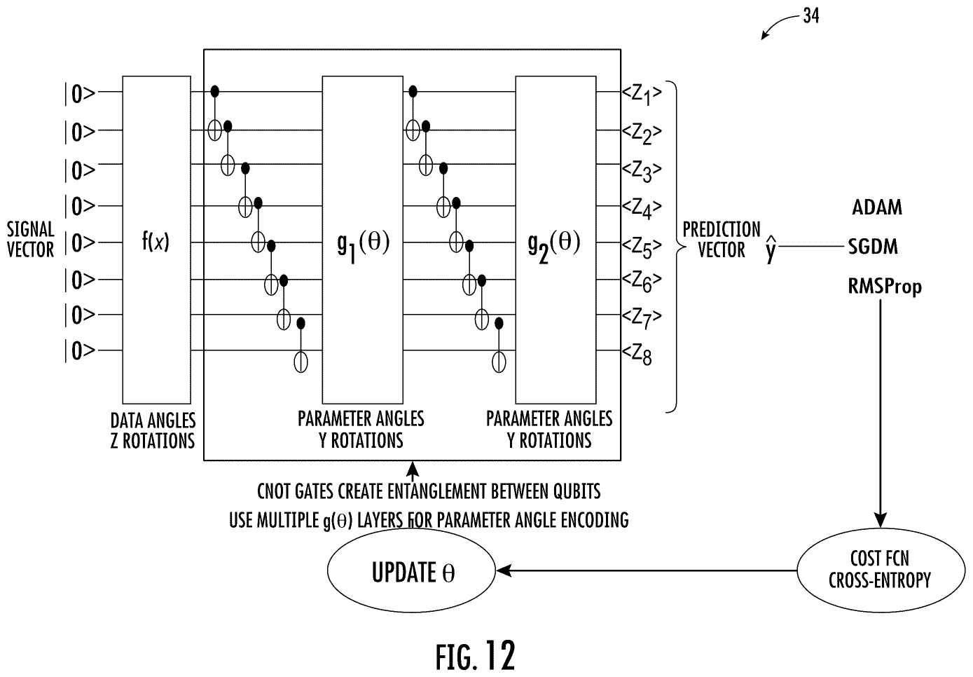

An example implementation of the classification module 34 which incorporates the above-noted QNN deep learning model approach is now described with reference to FIG. 12. The module 34 utilizes a game theoretic optimization to consider the three deep learning model solvers noted above (i.e., ADAM, SGDM, and RMSProp), although other solvers may also be used in different embodiments. The module 34 advantageously provides a cost function that minimizes parameters over the dataset. Cross-entropy measures the difference between estimator (data) and estimated value (prediction). Furthermore, the module 34 also minimizes g(θ) by gradient descent, which is a general function for minimizing a function.

Statistical pattern recognition requires a statistical relationship between features and class membership of a pattern. This process typically involves three steps: feature selection and feature extraction; selection of a distribution/density function and estimation of its parameters; and computation and test of a decision boundary. The distribution/density function may be selected based on understanding how features vary given the imaging process. Parameter estimation is based on samples of a training data set. The decision boundary consists of those locations in feature space where the class changes according to the computed maximum probability. The location of the decision boundary may include the cost of error. Testing the quality of the classifier may be dependent or independent of the selected distribution/density function. In an example embodiment, feature selection and extraction may be accomplished through supervised classification; estimation of parameters is accomplished through training; and decision boundary accuracies measured via Receiver Operating Characteristic (ROC) Curves.

A large body of research in supervised learning deals with the analysis of single label data, where training examples are associated with a single label from a set of disjoint labels. However, training examples in several application domains are often associated with a set of labels. Such data are called multi-label. The categorization of textual data, such as documents and web pages, is perhaps the dominant multi-label application. With the assistance of the quantum subset summing performed by the quantum computing circuit 31, the processor 32 makes a cognitive decision as to the best land use material classification per pixel.

Material classification is the semantic assignment, or labeling, of a color or multi-spectral image pixel to an index representing a material or group of materials making up a material mixture. The purpose of the assignment is to provide additional information—beyond the spectral characteristics of the pixel—to aid in the development of correlated sensor simulations and geo-specific content generation. Traditional material classification within the supervised learning process may pose certain challenges. One such challenge is limited training samples. Remote sensing imagery is rich with information on spectral and spatial distributions of distinct surface materials. Owing to its numerous and continuous spectral bands, hyperspectral data enables even more accurate and reliable material classification than panchromatic or multispectral imagery. However, high-dimensional spectral features, and the limited number of available training samples for supervised learning, may cause difficulties in material classification, such as overfitting in learning, noise sensitiveness, overloaded computation, and lack of meaningful physical interpretability.

Another challenge is the potential for thousands of variables. That is, the task is made more challenging by the fact that the number of spectral channels available for the detailed analysis of the materials is very large. The dimensionality of hyperspectral data may range from dozens to thousands of variables (spectral bands), which can prevent the successful application of standard pattern recognition techniques-especially in small sample size situations. This is known as the “curse of dimensionality”. To avoid these adverse effects on many learning systems, it is common to apply as a preprocessing step one of the many existing feature extraction (FE) or dimensionality reduction (DR) techniques.

Still another challenge is finding the discriminator. Feature extraction methods are also employed to establish more concentrated features for separating different materials, as not every spectral band contributes to material identification. Among them, discriminative feature extraction methods learn a suitable subspace where one can expect the separability between the different classes to be enhanced. Typical methods widely used for hyperspectral imagery include linear discriminant analysis and nonparametric weighted feature extraction, which design proper scatter matrices to effectively measure the class separability.

Object material identification in spectral imaging combines the use of invariant spectral absorption features and statistical machine learning techniques. The relevance of spectral absorption features for material identification casts the problem into a pattern recognition setting by making use of an invariant representation of the most discriminant band-segments in the spectra. The identification problem is a classification task, which is effected based upon those invariant absorption segments in the spectra that are most discriminative between the materials. To robustly recover those bands that are most relevant to the identification process, discriminant learning may be used.

Integration of geometrical features, such as the characteristic scales of structures, with spectral features may be for the classification of hyperspectral images. The spectral features, which only describe the material of structures, cannot distinguish objects made by the same material but with different semantic meanings (such as the roofs of some buildings and the roads). Geometrical features are typically used. Moreover, since the dimension of a hyperspectral image is usually very high, a linear unmixing algorithm may be used to extract the end members and their abundance maps to represent compactly the spectral information.

Enhancement of commercial satellite imagery is accomplished by merging and mosaicking multi-source satellite and aerial imagery of different resolutions on an elevation surface to provide realistic geo-specific terrain features. This requires that all data is orthorectified, seamlessly co-registered, tonally balanced, pan-sharpened and feather blended mosaics created from different resolution source data.

The pan-sharpened image 33 may be used (as opposed to original multispectral imagery) to perform classification, as the pan-sharpened product has higher fidelity (although the original imagery may be used in some embodiments). The processor 32 may determine the two dominant materials, as well as the relative abundance of each material, for each pixel in the data set. Available at the same pixel resolutions and precisely correlated to the true color product, the material classification data set may be desirable for creating various sensor views 38 of 40 to accompany out-the-window views within the simulation image generator. Material classification products can be used to create night vision, IR, and radar visual databases or for mapping high detail, geotypical textures with real-world accuracy. Output may be made available in Geotiff format, although other suitable formats may also be used.

Supervised classification techniques play a key role in the analysis of hyperspectral images, and a wide variety of applications may be handled by successful classifiers, including: land-use and land-cover (LULC) mapping, crop monitoring, forest applications, urban development, mapping, tracking and risk management. Conventional classifiers treat hyperspectral images as a list of spectral measurements. Classifiers use both spectral and spatial information. In addition, to reduce the redundancy of features and address the so-called curse of dimensionality, different supervised feature extraction (FE) techniques may be used. One way to improve the extraction of spatial information is to use different types of segmentation methods. Image segmentation is a procedure that can be used to modify the accuracy of classification maps.

To obtain the semantic assignment or labeling of a color, multi-spectral, or grayscale image pixel for material classification, supervised learning methods may be used. Supervised classification uses a training set representative of the real world information to “learn” about the information to properly classify and predict the selected input objects or feature representations. In addition to the limited number of training samples available mentioned earlier, the size and characteristics of the training set may have a noticeable effect on the results in both accuracy and precision. Other factors to consider for the training set are heterogeneity of data, redundancy in the data, and presence of interactions and non-linearity.

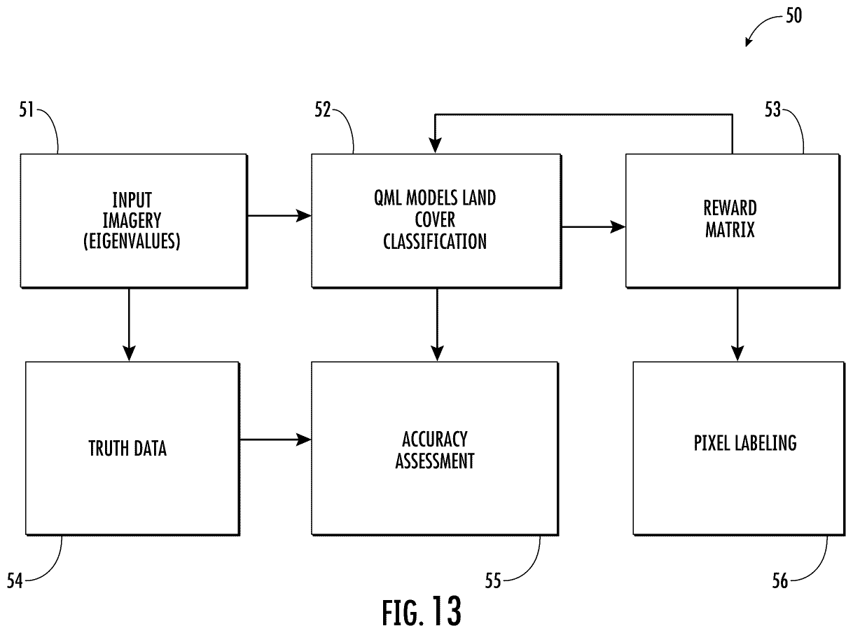

In the present application, supervised classification may involve a supervised learning technique generated from examples selected from multispectral imagery, saved and communicated by a training set in the form of a shapefile. This training consists of a portion of truth from image data. An example training approach which may be utilized by the processor 32 is shown in the flow diagram 50 of FIG. 13.

In order to assign a classification of features over an image, this approach applies supervised machine learning to the input imagery (eigenvalues) (Block 51) by creating a pairwise reward matrix of prediction probability confidence to choose which class to assign to each pixel by processing eigenvalues from pixel kernels. QML model land cover classification is performed on the input imagery (Block 52) and the reward matrix generated (Block 53) for performing the pixel labeling operations (Block 56), as discussed further above. Accuracy assessments (discussed further below) may be performed (Block 55) based upon the output of the land cover classification and truth data (Block 54) from prior input imagery where the various land cover features are known.

Supervised learning creates a classifier model that can infer the classification of a test sample using knowledge acquired from labeled training examples. In the present case, the trained classifier predicts if a small area of an image is a particular feature or not, and this is done over the whole test image. Each small image area is turned into a feature vector, and it is this vector that is passed to the classifier. To train the classifier, the image areas are manually labeled with a feature type and turned into feature vectors. The feature vector and label pairs are inputs to a machine-learning algorithm that produces a classifier model.

To achieve desired results, models with a good bias/variance trade-off leading to a higher generalization are desired, which allows a trained model to be applied to a wider variety of imagery. For example, if a model were trained over desert imagery yet also works well when testing over forested areas, then the model generalized well. There are many choices for machine-learning algorithms for training of data sets. By way of example, suitable machine-learning algorithms may include k-Nearest Neighbors (KNN), decision trees using a classification and regression tree (CART), Normal/Naïve Bayes probabilistic graphical model (PGM), and support vector machine (SVM).

KNN is the most simplistic algorithm, and simply looks at the k points (k is a chosen odd integer) in the training set that is closest in feature space distance to the test sample. KNN selects the feature class for the test based on the class label of the majority of the k closest training points.

CART uses the training data to create a tree, where each leaf node has a class label determined by the class label of the majority of training examples reaching that leaf. The internal nodes of the tree are questions based on the feature vectors; it branches based on the answers. When a test vector is applied to the tree, the vector obtains the label of the leaf it reaches.

The Bayes PGM treats test feature vectors as probabilistic evidence and infers the hidden classification state. Bayes PGM algorithm is naive because it makes the assumption that the evidence variables are independent, even though they frequently are not. The training data allows the PGM to learn the weights on the graph edges that maximize the expectation of correct inference.

The most sophisticated algorithm, SVM (with linear kernel), locates a linear separator of the training data with maximum margin. Training points that lie on the margin are considered as the support vectors. A simple linear calculation of a test vector with the support vector solution will generate a positive or negative value that indicates a feature classification of the test.

How well each model works is dependent upon feature properties, the quality and quantity of training data, and the parameter settings for the individual algorithms. Validation of the results may be considered to properly select the optimal model and model parameters for a given problem. If the labeled training data is distributed very non-linearly, then a linear learning method will be unlikely to fit the data well, resulting in a high bias, but may be generalized to some degree. If the training data is linearly separable and a highly non-linear based learning algorithm is used, then there may be an over-fit of the data, which may in turn suffer from high variance, and not be able to generalize well with the resulting output. Too little training data, or if the data is not a representative sample of the feature space, may result in accuracy and precision being negatively affected. However, if there is a high bias, additional training data could potentially make a model fit worse.

Various approaches may be used to generate a viable training set. In one example implementation using high-resolution satellite multispectral imagery, the imagery training set included points split approximately evenly among feature classes. The points defined a centroid from every feature in the truth set, which are polygonal shape files, and a set of random points from the non-feature polygons. The truth set may be seeded from an existing database in some embodiments.

In an example implementation, the four supervised learning algorithms discussed above were applied to several study areas. This is referred to as a local training set, meaning that the training samples are drawn from, and applied to, the same image. The concept of operations is to train on a small area and test on the larger surrounding area. Minimizing the number of false negatives (misses) was the first defined priority, and keeping the number of false positives down was the second priority. Extraction feature results were evaluated by comparing the extracted features with a truth set, here a feature shapefile created using automated methods and modified manually to meet established extraction requirements. A point grid shapefile was created within a regular 20 meter grid. This grid was then reduced to include only those points in the grid that lay with the union of the truth and the extracted features. The trimmed shapefile was modified to show relationships with the autonomously extracted features and truth set.

Further details regarding supervised learning are provided in “Optimizing Supervised Learning for Pixel Labeling and Material Classification” to Rahmes et al., Interservice/Industry Training, Simulation, and Education Conference (I/ITSEC) 2014, Paper No. 14016, which is hereby incorporated herein in its entirety be reference.

Quantum circuits with hierarchical structure have been used to perform binary classification of classical data encoded in a quantum state. Quantum circuits achieve good accuracy with performance robust to noise. These circuits can be used to classify highly entangled quantum states, which is generally not possible to do efficiently with classical computing approaches.

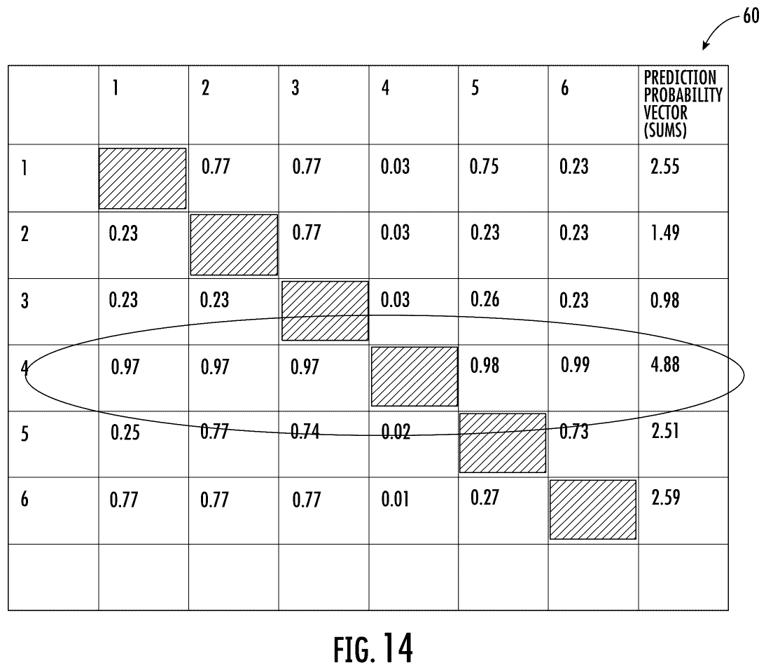

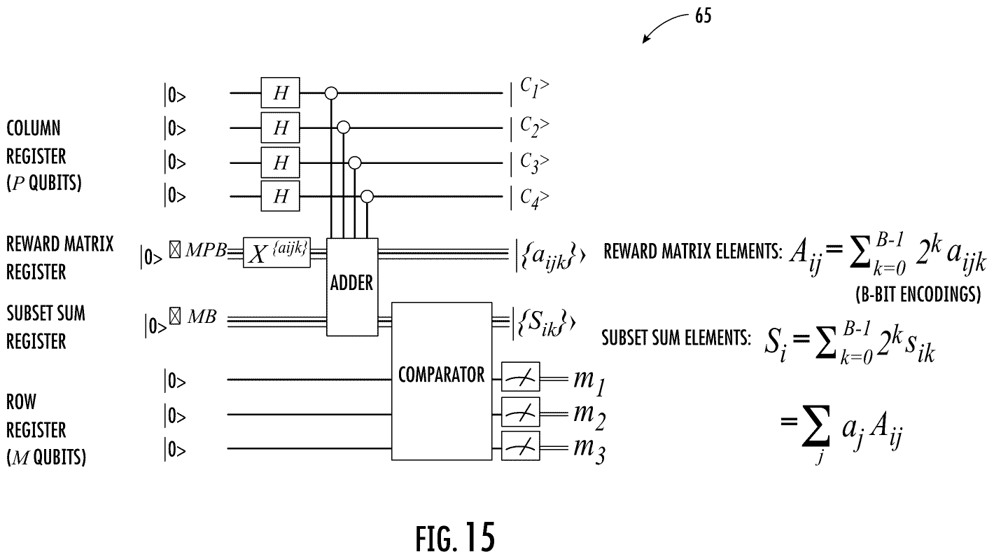

An example approach for performing quantum supervised classification is now described with reference to FIGS. 14-15. For this example, six general categories of land use features are utilized, namely: (1) bare earth; (2) building; (3) road; (4) tower; (5) trees; and (6) water. This results in fifteen possible pairs of land use classes (i.e., ½, ⅓, ⅔, ¼, 2/4, ¾, ⅕, ⅖, ⅗, ⅘, ⅙, 2/6, 3/6, 4/6, and ⅚). As noted above, quantum machine learning pairwise processing is used for multiple decision class options. More particularly, in the present example there are eight Eigenvalues to normalize the data between 0 and pi/2, and a vector length of 8 is used for the classification decision.

Pairwise comparison (also known as paired comparison) is a powerful tool for prioritizing and ranking multiple options relative to each other. It is the process of using a matrix-style tool to compare each option in pairs and determine which is the preferred choice, or has the highest level of importance based on defined criteria. At the end of the comparison process, each option has a rank or relative rating as compared to the rest of the options, as seen in the table 60 of FIG. 14. Note that the matrix template performs the calculation. If necessary or useful, the rankings may be converted to percentages. The prioritization ranking of the options is used for the next phase of the decision-making process. In the illustrated example, category (4) (tower) has the highest sum of prediction probability vectors at 4.88, and is therefore selected as the appropriate classification for the pixel of interest.

Another way of optimally choosing the best solver to predict the LULC class is to generate another reward matrix from the last column probability vector in table 60 for each solver, e.g., Adam, SGDM, and RMSProp. Subset summing may then be used to choose the best solver and LULC class.

An example approach for performing quantum approximation to a linear program using subset summing circuit 65 is now described with reference to FIG. 15. The comparator and adder shown in FIG. 15 may be similar to those described above with respect to FIGS. 5 and 6, respectively. At a first step, all qubits are initialized to |0>. Next, a reward matrix Aᵢⱼ is loaded into reward register:

$${A}_{i j} = {\sum }_{k = 0}^{B - 1} {2}^{k} {a}_{i j k}$$

with B-bit encoding of each matrix element. Next, a column register is placed in equal superposition through the application of the apply Hadamard gates (H), and controlled-sum operations are performed. In this implementation, the column register is the control, while the reward matrix and subset sum registers are the target. Comparator operations may then be performed in which the reward matrix sums compared and the row qubit corresponding to the highest sum is flipped. Amplitude amplification may then be performed on the row register, and the row register may be measured to extract the optimal pure strategy.

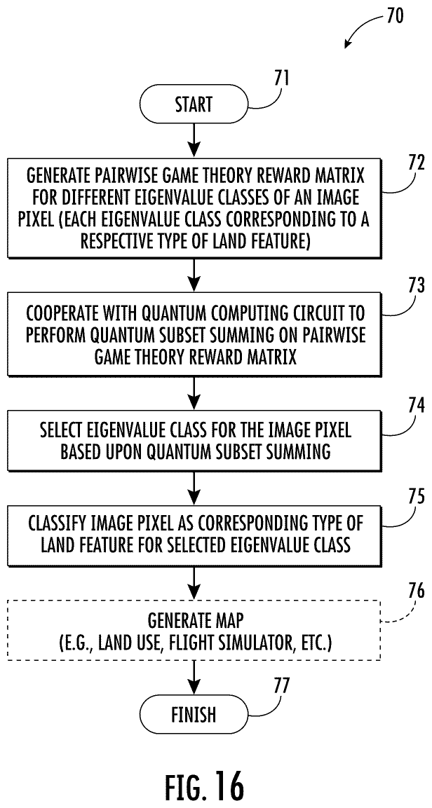

Referring additionally to the flow diagram 70 of FIG. 16, a related image pixel classification method is now described. Beginning at Block 71, the processor 32 generates a pairwise game theory reward matrix for a plurality of different classes of an image pixel (Block 72). As noted above, each class corresponds to a respective type of land feature from among a plurality of different types of land features. The processor 32 further cooperates with the quantum computing circuit 31 to perform quantum subset summing on the pairwise game theory reward matrix, at Block 73, and selects a class for the image pixel based upon the quantum subset summing, at Block 74. The processor 32 may then classify the image pixel as the corresponding type of land feature for the selected class, and optionally generate a map such as a land use map, flight simulator map, etc., as discussed further above. The method of FIG. 16 illustratively concludes at Block 77.

The above-described device 32 and quantum supervision techniques for pixel classification provide a number of technical advantages. For example, this approach provides a prediction probability confidence matrix for binary comparison for association of quantum neural network decisions. Moreover, it utilizes a quantum subset summing approximation in a quantum neural network to improve discriminative prediction accuracy with ensembling of circuits and multiple parameter sets with several different cost functions. The quantum subset summing approximation of the above-described approach allows for the offloading of that optimization to quantum computing devices that may more quickly solve it and return this information in near real-time to make the best decision.

The above-described approach also applies an optimal pixel-labeling process to the mosaic imagery. This process is based on AI algorithms using Nash Equilibrium and game theoretic analyses to help solve the problem of feature extraction through quantum supervised classification. As noted above, classification strategies may be based on different solvers, such as SGDM, Adam, and RMSProp. Within this formulation, a weighted reward matrix may be used for consistent labeling of feature pixels and classification factors. This advantageously results in higher accuracy and precision when compared to the individual machine learning algorithms alone.

Many modifications and other embodiments will come to the mind of one skilled in the art having the benefit of the teachings presented in the foregoing descriptions and the associated drawings. Therefore, it is understood that the disclosure is not to be limited to the specific embodiments disclosed, and that modifications and embodiments are intended to be included within the scope of the appended claims.

1. An image pixel classification device comprising:
a quantum computing circuit configured to perform quantum subset summing; and
a processor configured to
generate a pairwise game theory reward matrix for a plurality of different classes of an image pixel, each class corresponding to a respective type of land feature from among a plurality of different types of land features,
cooperate with the quantum computing circuit to perform quantum subset summing on the pairwise game theory reward matrix, and
select a class for the image pixel based upon the quantum subset summing, and classify the image pixel as the corresponding type of land feature for the selected class.

2. The image pixel classification device of claim 1 wherein the processor is configured to select a deep learning model from among a plurality thereof based upon the quantum subset summing on the pairwise game theory reward matrix, and classify the image pixel based upon the selected deep learning model.

3. The image pixel classification device of claim 2 wherein the plurality of deep learning models comprise an Adaptive Moment Estimation (ADAM) solver, a Stochastic Gradient Descent with Momentum (SGDM) solver, and a Root Mean Squared Propagation (RMSProp) solver.

4. The image pixel classification device of claim 1 wherein the plurality of different types of land features comprise at least some of bare earth, building, road, tower, vegetation and water.

5. The image pixel classification device of claim 1 wherein the processor is configured to generate a land map including the image pixel rendered according to its land feature classification.

6. The image pixel classification device of claim 1 wherein the processor is configured to generate a flight simulator map including the image pixel rendered according to its land feature classification.

7. The image pixel classification device of claim 6 wherein the processor is further configured to change the rendering of the image pixel based upon a plurality of different simulated weather conditions.

8. The image pixel classification device of claim 1 wherein the image pixel comprises a color image pixel.

9. The image pixel classification device of claim 1 wherein the image pixel comprises a grayscale image pixel.

10. An image pixel classification device comprising:
a quantum computing circuit configured to perform quantum subset summing; and
a processor configured to
generate a pairwise game theory reward matrix for a plurality of different classes of an image pixel, each class corresponding to a respective type of land feature from among a plurality of different types of land features,
cooperate with the quantum computing circuit to perform quantum subset summing on the pairwise game theory reward matrix,
select a class for the image pixel and a deep learning model from among a plurality thereof based upon the quantum subset summing,
classify the image pixel as the corresponding type of land feature for the selected class based upon the selected deep learning model, and
generate a map including the image pixel rendered according to its land feature classification.

11. The image pixel classification device of claim 10 wherein the plurality of deep learning models comprise an Adaptive Moment Estimation (ADAM) solver, a Stochastic Gradient Descent with Momentum (SGDM) solver, and a Root Mean Squared Propagation (RMSProp) solver.

12. The image pixel classification device of claim 10 wherein the plurality of different types of land features comprise at least some of bare earth, building, road, tower, vegetation and water.

13. The image pixel classification device of claim 10 wherein the map comprises a land map.

14. The image pixel classification device of claim 10 wherein the map comprises a flight simulator map.

15. The image pixel classification device of claim 14 wherein the processor is further configured to change the rendering of the image pixel based upon a plurality of different simulated weather conditions.

16. The image pixel classification device of claim 10 wherein the image pixel comprises at least one of a color image pixel and a grayscale image pixel.

17. An image pixel classification method comprising:
at a processor,
generating a pairwise game theory reward matrix for a plurality of different classes of an image pixel, each class corresponding to a respective type of land feature from among a plurality of different types of land features,
cooperating with a quantum computing circuit to perform quantum subset summing on the pairwise game theory reward matrix, and
selecting a class for the image pixel based upon the quantum subset summing, and classify the image pixel as the corresponding type of land feature for the selected class.

18. The method of claim 17 further comprising, at the processor, selecting a deep learning model from among a plurality thereof based upon the quantum subset summing on the pairwise game theory reward matrix, and classifying the image pixel based upon the selected deep learning model.

19. The method of claim 18 wherein the plurality of deep learning models comprise an Adaptive Moment Estimation (ADAM) solver, a Stochastic Gradient Descent with Momentum (SGDM) solver, and a Root Mean Squared Propagation (RMSProp) solver.

20. The method of claim 17 wherein the plurality of different types of land features comprise at least some of bare earth, building, road, tower, vegetation and water.

21. The method of claim 17 further comprising, at the processor, generating a land map including the image pixel rendered according to its land feature classification.

22. The method of claim 17 further comprising, at the processor, generating a flight simulator map including the image pixel rendered according to its land feature classification.

23. The method of claim 22 further comprising, at the processor, changing the rendering of the image pixel based upon a plurality of different simulated weather conditions.

24. The method of claim 17 wherein the image pixel comprises at least one of a color image pixel and a grayscale image pixel.
